(19) United States
(12) Patent Application Publication
(10) Pub. No.: US 2009/0106054 A1
(43) Pub. Date: Apr. 23, 2009

(54) CLINICAL DATA EVALUATION AND SCORING FOR NON CLINICAL PURPOSES SUCH AS BUSINESS METHODS FOR HEALTH INSURANCE OPTIONS

(76) Inventor: Oded SAREL, Even Yehuda (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/344,853

(22) Filed: Dec. 29, 2008

Related U.S. Application Data
(63) Continuation-in-part of application No. PCT/IL2007/000767, filed on Jun. 25, 2006.

(30) Foreign Application Priority Data
Jun. 25, 2006 (IL) 176540

(51) Int. Cl. G06Q 40/00

(52) U.S. Cl. 705/4

(57) ABSTRACT

A method of doing business is disclosed for the sale of insurance options. An individual is assigned a Health Risk Score (HRS); in a preferred embodiment, the HRS is determined by using an automated case-based method for assessing risk. The individual may then purchase an option for insurance coverage that will begin only after a predetermined period of time. At the beginning of that period, the individual's HRS is re-evaluated, and if it remains within predetermined acceptable limits, the individual may then obtain insurance coverage with premiums and benefits defined at the time of the purchase of the option. A case-based method for assessing risk is disclosed, in which various risk factors and their combinations are used to provide a scoring matrix. This scoring matrix is then used to evaluate the individual's HRS.

### CROSS-REFERENCE TO RELATED APPLICATION

This application is a continuation-in-part of PCT Application PCT/IL2007/000767, filed Jun. 25, 2006.

### FIELD OF THE INVENTION

This invention relates to methods for the sale of insurance options, that is, when a customer pays for option to purchase insurance coverage in the future even if the underwriting score will deteriorate which will only enter into force some time after the initial risk assessment is made and the option has been purchased, and to methods for assessment of one or more subjects. In particular, the invention relates to such options for health insurance and to methods for assessing the risk associated with the health or lifestyle of the individual seeking insurance.

### BACKGROUND OF THE INVENTION

The Consolidated Omnibus Budget Reduction Act of 1986 (COBRA) contains inter alia provisions for continuation of group health insurance coverage for people whose health insurance had been obtained through their employer, but whose employment was terminated (or whose working hours were reduced), as well as for employees' ex-spouses who might lose their health insurance benefits upon death of or divorce from the employee who was the primary beneficiary of the group health insurance benefits. In general, however, the beneficiary is only entitled to 18 months of coverage following termination of employment; details of the coverage extensions mandated by COBRA may be found at the web site of the Department of Labor (http://www.dol.gov/ebsa/pdflcobraemployee.pdf).

During the period between the completion of the 18 months of continuation coverage and eligibility for Medicare, the individual is responsible for finding his own health insurance. In general, private health insurance is significantly more expensive than group health insurance obtained through an employer. Thus, there is a need for means for providing reasonably priced health insurance coverage for otherwise healthy individuals who have lost their group insurance coverage due to termination of employment, divorce from a covered spouse, etc.

Associated with any kind of insurance is the necessity for the underwriter to assess the risk associated with the individual seeking insurance in order for the underwriter to be able to calculate the premium appropriate to the individual and his risk level in order that on average the total amount paid by the individual in premiums will be enough to cover the cost to the insurer if and when the insurer is required to pay the insured.

Although an underwriter should not rely on his/her judgement alone to make decisions, there are no formal training programs to prepare an underwriter for this specialized role. Reinsurance companies often help by providing manuals and holding seminars to arm underwriters with as much knowledge as possible. In a number of instances, these guides have been adapted into electronic form in order to make them easier to use and to automate some aspects of the assessment process. Nevertheless the underwriter relies largely upon his own experience and as are result, a subjective element is introduced into the underwriting process.

To assist the underwriter, a life assurance company will utilize the services of its Chief Medical Officer, a fully qualified doctor, to provide medical expertise in the more complex cases. Even the most qualified doctor cannot be expected to have a detailed knowledge of all aspects of medicine and diseases, however.

Thus, the more information that the underwriter can access during the application the smaller the risk will be to insurer. To this end it is necessary to develop methods by which as much accurate information can be gathered as quickly as possible. Over the last twenty years, for a variety of reasons, traditional sources of information have been becoming progressively less reliable. Legislation has limited the freedom with which a family doctor can divulge medical information where the doctor feels it is not in the interest of the patient. In addition, the rate of medical progress is such that it is impossible for a Chief Medical Officer to keep abreast of all the latest developments.

Automated underwriting systems have been developed to improve the efficiency of the process. Most of these systems comprise a data gathering phase and a processing phase. The data gathering phase might make use of the gathering of information directly from the applicant particularly over the phone (tele-interviewing). Various models exist for tele-interviewing but in general it is an efficient way for less expensive personnel to gather information for processing.

For example, WO patent application 03058380 describes a system to structure and summarize the information obtained from doctors' reports by capturing relevant variables that characterize a given medical impairment, which could allow an automated reasoning system to determine the degree of severity of such impairment and to thus estimate the underlying insurance risk. This invention specifically aims to standardize the medical report. US patent application 2005144047 describes a more general system comprising a plurality of browsers each of which serves as a station at which information can be entered and communicated to a dispatcher and parses the information to be used in the selection of an insurance process.

The processing phase can also be automated by means of rules. Presently rules take the form of if-when conditions with each condition providing a unique rule. Even systems such as that described in WO patent application 03065268 which provide for the possibility of fuzzy logic, allowing intermediate values between absolute true and false, do so by means of creating two if-then conditions each of which determines one extreme of the range of allowed values.

The outcome of these rules can determine for example if an applicant should be rejected, accepted, or conditionally accepted either with payment of an additional premium or with certain specified exclusions. Because each rule needs to be entered individually the initial set up of the system is very time consuming and once set up the system is not easily updated. As a result, it is not cost effective to create rules describing less common cases and the rules cannot rapidly respond to advances in medicine. Therefore, current automated systems provide only limited automation and usually only of the initial underwriting phases.

What is needed is an adaptable software system for the medical underwriting process, producing an accurate, objective, reliable and rapid underwriting decision for any given insurance product based on the specific insurer underwriting philosophy.

The present invention is designed to meet these two long-felt needs: the need to provide health insurance coverage for an individual who loses his or her group health insurance benefits due to termination of employment, and the need for an accurate and objective underwriting system that will enable the insurer to assess the risk associated with that individual at the commencement of his or her employment.

### SUMMARY OF THE INVENTION

The current invention discloses a new tool enabling, inter alia:
sale of options for increasing an individual's insurability with respect to personal insurance (life, annuities, long term care, health, etc.);
securitization of and individual's personal insurance portfolio.

Selling options for increasing long-term insurability as disclosed in the present patent application is a new tool that enables the securing of insurance underwriting terms for pre-defined period, up to a certain degree of health status change. This product will allow selling, for a substantially low price, pre-insurance to healthy young customers, that is, insurance that does not take effect for a predetermined period after the sale of the option.

Facilitation of such a product depends on the existence of an objective personal health index tool. “Computerized underwriting software” is an objective health scoring and automated medical underwriting tool, which enables the reaching of underwriting decision for any properly filled-in medical questionnaire, resulting in a standardized, replicable, and objective medical underwriting solution.

The accumulation of medical scoring and periodic re-evaluations will enable us to create new insurance tools. The insured will be able to add options for increased insurability to insurance policies purchased while he or she is still young and in good health. The price of the option will be determined at the entry age, and will enable buying more coverage to become effective only at a predefined future date, independent of the state of health of the person in the future. Such an approach limits the moral hazard effects which are present when a person wants to buy more insurance at an older age, and thereby it reduces the premium level for all insured.

The option may have the following criteria, presented as non-limiting examples:
The insured may make use of the option only up to a certain limited degree of health status changes as measured by the objective computerized underwriting software score.
Specific policy with specific wording
Valid until a specific date
Up to a predefined risk

The computerized underwriting software score will enable exact definition of the criteria by which health status changes are measured, and objective measurements of the magnitude of health status changes, but will still entitle the customer to purchase a policy, even if there is a change in his or her health status. The price of the policy will be determined by the individual's age and health at the time of the purchase of the option, with no influence from any medical problem subsequently incurred. The difference between the premium agreed upon at the time of purchase of the option and the premium paid upon the individual's making use of the option will be paid by the option's dealer, who may or may not be the insurance company that is the actual policy producer.

This program can be very attractive to the US labor market, including large corporations and leading labor unions. This is because, if an individual does not find employment with a large employer following termination of employment, purchase of health and life insurance is likely to be difficult or impossible, especially in the case of substantial deterioration of the individual's health. This obstacle is a major contributor to the phenomenon of the large number of people in the United States who lack insurance.

Another tool that can be developed with the aid of the medical scoring method herein disclosed is the securitization of insurance portfolios. An insurance company will be able to select a portfolio of insured people within a particular scoring range as determined by the computerized underwriting software, and then to securitize it. This will enable the company to issue financial instruments (for example, bonds with variable interest rates—similar to longevity bonds) according to the changes in the scoring of the health of the insured within the portfolio. Through securitization, a company can reduce its risks by transferring them to other entities, and can thus lower the cost of borrowing funds. Furthermore, securitization may lower the company's capital requirements so that it can better handle any asset-liability mismatch. This ability will then open the way to a vast number of possibilities and to a huge world financial market.

It is thus an object of the present invention to disclose a business method for personal insurance options (IOs), comprising the steps of: (a) defining an acceptable health risk score (HRS); (b) defining a set of insurance premiums and benefits to be offered to an individual after a predetermined period of time; (c) using a health scoring tool (HST) to calculate an HRS for an individual; (d) calculating a periodic IO fee for said individual; (e) selling said individual said an IO in exchange for agreement to pay said periodic IO fee; (f) using an HST to calculate a second HRS after said predetermined length of time defined in step (b); (g) offering insurance coverage to said individual if said second HRS is acceptable according to the definition of step (a), said offer remaining valid for a predetermined time after the completion of the period of time defined in step (b) as long as said individual's HRS remains acceptable as defined in step (a); and (h) providing insurance coverage to said individual upon said individual's acceptance of said offer of health insurance coverage. It is within the essence of the invention wherein said insurance coverage is provided with said set of premiums and benefits as defined in step (b).

It is a further object of this invention to provide such a business method, wherein at least one of said HSTs is automated and/or computerized.

It is a further object of this invention to provide such a business method, wherein he HST of step (f) is identical to the HST of step (c).

It is a further object of this invention to provide such a business method, wherein the periodic IO fee is calculated based on criteria chosen from the group consisting of (i) the acceptable HRS as defined in step (a); (ii) the length of said predetermined period as defined in step (b); (iii) the length of the period of validity of said offer as defined in step (g); (iv) the age of said individual at the end of said predetermined period as defined in step (b); (v) any combination of the above.

It is a further object of this invention to provide such a business method, wherein the IO is a health insurance option, and further comprising the additional steps of: (a) accepting said individual into a group health insurance plan (GHIP), said GHIP affiliated with said individual's employer; (b) assigning the beginning said predetermined period of time as defined in step (b) to the day after the last day of said individual's membership in said GHIP; (c) offering said individual health insurance coverage, said predetermined period of validity of said offer beginning the day after the last day of the longest continuation period of those in the group consisting of (i) the continuation period mandated by COBRA, (ii) the continuation period mandated by any other local, state, or federal law, statute, or regulation, and (iii) the continuation period mandated by company policy, and ending the day that said individual's HRS falls outside of said predetermined acceptable limit; and (d) providing said individual health insurance coverage upon said individual's acceptance of said offer of health insurance coverage. It is within the essence of the invention wherein said health insurance coverage is provided with the same premiums and benefits as provided by said GHIP on the last day of the continuation period of step (f).

It is a further object of this invention to disclose such a business method, wherein said GHIP is provided to said individual by said individual's employer as self-insurance.

It is a further object of the present invention to disclose such a business method, wherein said step of offering said individual health insurance coverage remains valid during a period of time beginning the day after said continuation period ends and ending the earliest of (a) a predetermined expiration date; (b) the day that said individual's HRS falls below a predetermined threshold value; and (c) the day that said individual becomes eligible to receive Medicare benefits.

It is a further object of the present invention to disclose such a business method, wherein said health insurance coverage is provided with the same premiums and benefits as provided by said GHIP on the day that said offer is accepted by said individual.

It is a further object of this invention to disclose such a business method, further comprising the additional step of creating a plurality of HIOs, each of said HIOs having a predetermined unique set of benefits; wherein said step of calculating a periodic HIO fee further comprises the step of calculating a periodic fee for each of said plurality of HIOs; and further wherein the step of selling said individual said HIO in exchange for agreement to pay said periodic HIO fee further comprises the step of selling said individual at least one of said plurality of HIOs in exchange for agreement to pay the periodic fee associated with said HIO.

It is a further object of this invention to disclose such a business method, wherein said health insurance coverage is provided with a predetermined set of benefits, said set of benefits are similar or more restrictive than those provided by said GHIP.

It is a further object of this invention to disclose such a business method, wherein said individual retains the right to make use of said HIO after the conclusion of said continuation period in the event that said individual's HRS falls below said threshold value during the period of said individual's participation in said GHIP.

It is a further object of this invention to disclose such a business method, wherein at least one of said plurality of HIOs for different overages and for the same coverage divided to multiple portions, includes the retention of the right to make use of said HIO after the conclusion of the pre-defined non eligibility period and/or said continuation period in the event that said individual's HRS falls below said threshold value during the non eligibility period and/or the period of said individual's participation in said GHIP, and further wherein said periodic fee for said HIO is higher than the fee for an HIO that is otherwise identical but does not contain any provision for the event of said individual's HRS falling below said threshold during said period of participation in said GHIP.

It is a further object of this invention to disclose such a business method, wherein the right to make use of said HIO expires a predetermined period after the expiration of the predefined option exercising right period and/or said continuation period.

It is a further object of this invention to disclose such a business method, further comprising the additional step of suspending said health insurance coverage during any period of time during which said individual obtains employment that includes the option of joining a GHIP.

It is a further object of this invention to disclose such a business method, further comprising the additional step of resuming collection of said periodic HIO fee during said period of time during which said health insurance coverage is suspended.

It is a further object of this invention to disclose such a business method, wherein after said individual becomes eligible to receive Medicare benefits, said HIO includes health insurance coverage as a supplement to Medicare benefits.

It is a further object of this invention to disclose such a business method, wherein said supplement to Medicare benefits comprises a predetermined set of benefits, said set of benefits more restrictive than those provided by said GHIP, and further wherein the premium for participation in said health insurance coverage is reduced relative to the premium for participation in said GHIP.

It is a further object of this invention to disclosed such a business method, further comprising the additional steps of: (a) performing the step of using an HST to calculate an HRS for each of a plurality of individuals; (b) selecting from within said plurality of individuals a group of individuals all of whom have an acceptable HRS; and (c) calculating a periodic IO fee for each of said individuals, said IO fee identical for each of said individuals. It is within the essence of the invention wherein said IO fee is calculated based on criteria selected from the group consisting of (i) the acceptable HRS; (ii) the length of said predetermined period as defined above; (iii) the average age of said individuals in said group; (iv) the average HRS of said individuals in said group; (v) the average age of said individuals at the end of said predetermined period as defined above; (vi) the length of the period of validity of said offer as defined above; (vii) any combination of the above.

It is a further object of this invention to disclose a case based method of data analysis for use in risk assessment comprising: (a) compiling a set of influencing factors; (b) constructing at least one scoring matrix comprising n rows and n columns, where n is an integer equal to the number of influencing factors, said scoring matrix constructed by (1) assigning each row of said scoring matrix to an influencing factor; (2) assigning each column of said scoring matrix to an influencing factor; and (3) assigning a risk score value to each cell in the scoring matrix, said risk score values corresponding to the combined influences of the influencing factors associated with the row and column defining the location of said cell within said scoring matrix; (c) obtaining data about at least a portion of the set of influencing factors in at least one case; and (d) determining an overall response for each case.

It is a further object of this invention to disclose such a method, additionally assigning a plurality of risk score values to each cell of said scoring matrix such that a plurality of total risk scores are calculated.

It is a further object of this invention to disclose such a method, additionally assigning a value of at least one combined risk score associated with at least two combined influencing factors that is greater than or equal to the sum of the individual risk scores associated with each influencing factor alone.

It is a further object of this invention to disclose such a method, additionally assigning a value of at least one combined risk score associated with at least two combined influencing factors that is lower than or equal to at least one of the individual risk scores associated with each influencing factor alone.

It is a further object of this invention to disclose such a method, additionally identifying at least one critical influencing factor, such that where no data is obtained about said critical influencing factor no risk score is returned.

It is a further object of this invention to disclose such a method, additionally providing a means, especially a database, of storing data obtained from a plurality of cases.

It is a further object of this invention to disclose such a method, additionally labelling at least one reference set of influencing factor values as significant and providing an alert where a given case approximately matches said reference set.

It is a further object of this invention to disclose such a method, additionally providing risk scores for sets containing a plurality of individual cases, especially by averaging or summing all the risk scores of the individual cases in said set.

It is a further object of this invention to disclose such a method, additionally providing a team, comprising a plurality of experts with expertise in a plurality of fields, which determines the risk score values assigned to each cell in the scoring matrix.

It is a further object of this invention to disclose such a method, additionally providing a remote means especially tele-interviewing of remotely obtaining data.

It is a further object of this invention to disclose such a method, additionally updating risk score values after a fixed period of time.

It is a further object of this invention to disclose such a method, additionally providing a plurality of responses for a plurality of insurance types, selected from a group including life, health, medical, occupational, vocational, travel, financial insurance types or any combination thereof.

It is a further object of this invention to disclose such a method, additionally adapting the risk score values of said matrix to suit a particular user.

It is a further object of this invention to disclose such a method, additionally providing a manual override option.

It is a further object of this invention to disclose such a method, providing automation of the complete underwriting process from application to determining premium and extent of coverage.

It is a further object of this invention to disclose such a method, additionally constructing at least a portion of an n-dimensional matrix and providing at least a portion of the risk score values associated with any combination of a plurality of influencing factors.

It is a further object of this invention to disclose a case based system of performing data analysis for use in risk assessment comprising: (a) a set of influencing factors; (b) a scoring matrix comprising n rows and n columns, where n is the number of influencing factors wherein (1) each row of said scoring matrix is assigned to a unique influencing factor; (2) each column of said scoring matrix is assigned to a unique influencing factor; and (3) a risk score value is assigned to each cell in the scoring matrix, said risk score values corresponding to the combined influences of the influencing factors associated with the row and column defining the location of said cell within said scoring matrix; (c) a database containing data pertaining to at least a portion of the set of influencing factors in at least one case; and (d) a means of determining a total risk score for each case, especially by summing the risk score values assigned to all the cells of said scoring matrix which are pertinent to the data obtained.

It is a further object of this invention to disclose such a system, additionally comprising a plurality of risk score values assigned to each cell of the scoring matrix such that a plurality of total risk scores are calculated.

It is a further object of this invention to disclose such a system, wherein the value of at least one combined risk score associated with at least two combined influencing factors is greater than or equal to the sum of the individual risk scores associated with each influencing factor alone.

It is a further object of this invention to disclose such a system, wherein the value of at least one combined risk score associated with at least two combined influencing factors is lower than or equal to at least one of the individual risk scores associated with each influencing factor alone.

It is a further object of this invention to disclose such a system, additionally comprising at least one critical influencing factor, such that where no data is obtained about said critical influencing factor, no risk score is returned.

It is a further object of this invention to disclose such a system, additionally comprising a means, such as a database, of storing data obtained from a plurality of cases.

It is a further object of this invention to disclose such a system, additionally comprising at least one reference set of influencing factor values which are labelled as significant and a means of alerting the user where a given case approximately matches said reference set.

It is a further object of this invention to disclose such a system, additionally comprising risk scores for sets containing a plurality of individual cases calculated for example by averaging or summing all the risk scores of the individual cases in said set.

It is a further object of this invention to disclose such a system, additionally comprising a team comprising a plurality of experts with expertise in a plurality of fields, said team determining the risk score values assigned to each cell in the scoring matrix.

It is a further object of this invention to disclose such a system, additionally comprising a remote means, especially tele-interviewing, of remotely obtaining data.

It is a further object of this invention to disclose such a system, additionally comprising a means of updating risk score values after a fixed period of time.

It is a further object of this invention to disclose such a system, additionally comprising a plurality of responses for a plurality of insurance types selected from the group consisting of life, health, medical, occupational, vocational, travel, financial insurance types or any combination thereof.

It is a further object of this invention to disclose such a system, additionally comprising a means of adapting the risk score values of said matrix to suit a particular user.

It is a further object of this invention to disclose such a system, additionally comprising a means of providing a manual override.

It is a further object of this invention to disclose such a system, additionally comprising a means of automating of the complete underwriting process from application to determining premium and extent of coverage.

It is a further object of this invention to disclose such a system, additionally comprising the steps of (a) constructing at least a portion of an n-dimensional matrix; (b) associating each of the n axes with a particular influencing factor; and (c) assigning the risk score values associated with any combination of influencing factors to the n-dimensional cell the position of which is defined by the intersection of the axes associated with said n influencing factors for at least a portion of said cells in said n-dimensional matrix.

It is a further object of this invention to disclose a case based method of data analysis for use in risk assessment comprising: (a) compiling a set of influencing factors; (b) constructing a scoring matrix comprising l rows and m columns, where l and m are integer multiples of the number of influencing factors, said scoring matrix constructed by (1) assigning each row of said scoring matrix to a unique influencing factor; (2) assigning each column of said scoring matrix to a unique influencing factor; and (3) assigning risk score values to each cell in the scoring matrix which correspond to the combined influence of both the cell's row and column influencing factors; (c) obtaining data about at least a portion of the set of influencing factors in at least one case; and (d) determining a total risk score for each case.

It is a further object of this invention to disclose a case based system of performing data analysis for use in risk assessment comprising: (a) a set of influencing factors; (b) a scoring matrix comprising l rows and m columns, where l and m are integer multiples of the number of influencing factors, wherein (1) each row of said scoring matrix is assigned to a unique influencing factor; (2) each column of said scoring matrix is assigned to a unique influencing factor; and (3) risk score values are assigned to each cell in the scoring matrix which correspond to the combined influence of both the cell's row and column influencing factors; (c) a database containing data pertaining to at least a portion of the set of influencing factors in at least one case; and (d) a means of determining a total risk score for each case, for example by summing the risk score values assigned to all the cells of said scoring matrix which are pertinent to the data obtained.

It is a further object of this invention to disclose a business method as described above, wherein the HST comprises any embodiment of the case-based system or method defined above.

It is a further object of this invention to disclose a business method as described above, further comprising the additional steps of: (a) determining an HRS range; (b) selecting a portfolio of insured individuals within said HRS range; and (c) issuing financial instruments secured by said portfolio.

It is a further object of this invention to disclose such a business method, wherein said step of determining an HRS range further comprises the additional step of using any embodiment of the case-based system or method defined above to determine said HRS range.

### BRIEF DESCRIPTION OF THE FIGURES

FIG. 1 shows a schematic timeline of the method disclosed in one embodiment of the current invention.

FIG. 2 represents, in the form of a flow diagram, the main stages towards determining the total risk score for a particular case, according to one embodiment of the current invention.

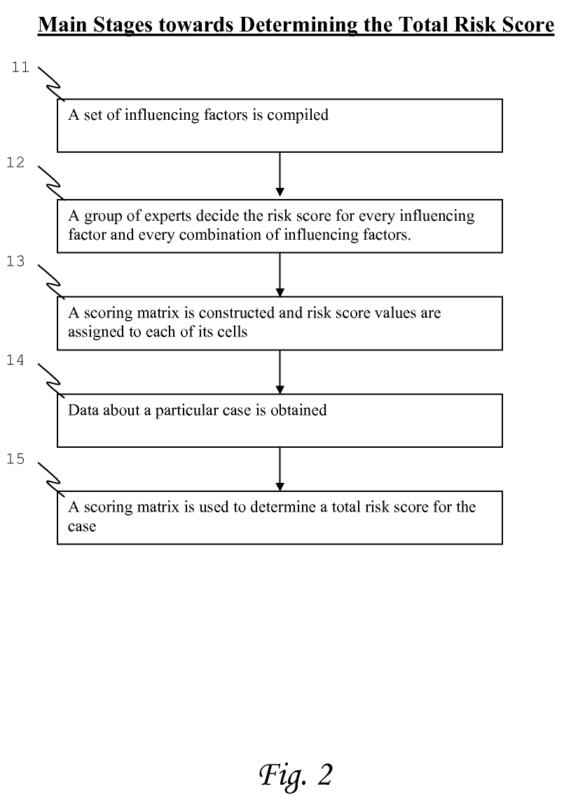

FIG. 3 represents a greatly simplified example of a scoring matrix for life assurance underwriting, according to another embodiment of the current invention.

FIG. 4 represents a greatly simplified example of a scoring matrix for health insurance underwriting, according to another embodiment of the current invention.

### DETAILED DESCRIPTION OF THE INVENTION

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the figure and described in the specification, but only as indicated in the accompanying claims, with the proper scope determined only by the broadest interpretation of said claims.

As used herein, the term “plurality” refers to any number greater than or equal to one.

As used herein, the terms “about” or “approximately” in the context of a numerical value refers to any value in a range from 20% below to 20% above the stated value.

As used herein, the term “underwriting” refers to the process whereby an insurer or reinsurer reviews applications submitted for insurance or reinsurance coverage and determines whether it will provide all or part of the coverage being requested and at what premium.

As used herein, the term “insurance” refers to a plan whereby a first party pays premiums to a second party, who in return, agrees to reimburse the first party in case of loss.

As used herein, the term “personal insurance” refers to an insurance plan as defined above wherein the first party is an individual, and the loss against which the second party agrees to reimburse the first party can be any kind of loss. Life insurance, health insurance, property insurance, and automobile insurance are common (non-limiting) examples of “personal insurance” as the term is used herein.

As used herein, the term “group insurance plan” refers to any insurance plan in which an individual is provided insurance as defined above due to his or her membership within a predetermined group of people (as a non-limiting example, the group of people may be the employees of a particular employer, or members of a particular Health Maintenance Organization).

As used herein, the term “reinsurance” refers to an insurance plan wherein one insurer pays premiums to a second insurer, who in return, agrees to at least partially reimburse the first insurer in case of a claim being made against the first insurer.

As used herein, the term “insurer” refers to a party providing insurance coverage.

As used herein, the term “influencing factor” refers to any agent which causally affects an outcome. In particular, the term refers to a condition that may increase or decrease the probability of a particular outcome.

As used herein, the term “scoring matrix” refers to a matrix containing risk score values related to combinations of at least two influencing factors.

As used herein, the term “risk score value” refers to a value assigned to a given combination of factors and which reflects the degree to which said combination of factors influences the probability of an outcome.

As used herein, the term “total risk score” refers to the overall risk score reflecting the influence of all known influencing factors of a particular case. This total risk score can be calculated, for example, by summing or averaging all the risk scores assigned to the combinations of all pairs of influencing factors in a particular case.

As used herein, the term “health risk score” (HRS) refers to a risk score that is based on the current level of health of the individual or group being assigned a risk score.

As used herein, the term “health scoring tool” (HST) refers to any standardized method for calculating a health risk score.

As used herein, the term “case” refers to any subject undergoing assessment. For example a case could be, in a non-limiting manner, an individual applying for life assurance, a shipping company applying for insurance coverage for cargo, a patient undergoing diagnosis, a subject of health assessment or any other subject being assessed.

As used herein, the term “case based method of data analysis” refers to the analysis of data pertaining to a particular case. In case based data analysis, the data related to the particular case is processed so as to obtain a result. This is not the same as initially performing analysis of data of larger populations to which the specific case at hand is later compared.

As used herein, the term “risk assessment” refers to an analysis of a subject providing a measure of the probability that a given outcome will occur to the subject. In addition, risk assessment can consider the potential consequences of said outcome occurring. Examples include, inter alia, health or other insurance assessment, life assurance assessment, medical diagnosis or any other analysis of data.

As used herein, the term “application question” refers to a question asked to an insurance applicant in order to gain information pertaining to the risk associated with his or insurance coverage.

As used herein, the term “application response” refers to information obtained in response to an application question.

As used herein, the term “matrix” refers to an n-dimensional array of cells, where n is equal to or greater than 2.

As used herein, the term “cell” refers to a data containing unit. In particular the term refers to one of a set of data containing unit elements constituting a table or matrix.

As used herein, the term “tele-interviewing” refers to the remote gathering of data by either manual or automatic means. It is noted that said gathering of data may be at the point of sale and may be effected by means of telephone, internet, computer station or any other means of data gathering.

As used herein, the term “premium” refers to regular periodic payments that a policyholder makes in order to own an insurance policy.

As used herein, the term “exclusions” refers to specific risks within an insurance policy which the insurer specifies as not covered in a particular policy.

As used herein, the term “extent of coverage” refers to the existence or otherwise of exclusions in a policy.

As used herein, the term “insurance type” refers to the nature of the risk covered by an insurance policy.

As used herein, the term “manual override” refers to a means for an underwriter to determine the premium and extent of cover associated to a given insurance policy independently of any data held by a system.

As used herein, the term “health insurance option” (HIO) refers to health insurance coverage that is paid for at a particular time, or over a period of time, but which does not become effective until a predetermined later time.

As used herein, the term “make use of an HIO” refers to the choice to begin health insurance coverage provided by an HIO as defined above. Thus, “making use of an HIO” refers to the beginning of the period of health insurance coverage rather than to the entire period of health insurance coverage.

As used herein, the term “periodic HIO fee” refers to a fee that can be paid in a plurality of payments, each payment coming due a specified interval after the previous one. As used herein, the term “periodic” does not imply that each payment is identical.

As used herein, the term “continuation period” refers to the period during which an individual retains the right to continue his or her health insurance under the same terms as those obtained under his or her GHIP. For example, in cases in which COBRA is in force, the continuation period is that mandated by COBRA. While the majority of the examples assume that the continuation period is that currently required by COBRA, the term itself refers to the period of time independent of any means by which it is calculated and independent of any law, statute, regulation, or policy by which it is mandated. Even in specific examples or exemplary embodiments in which the continuation period as used in the method herein disclosed is described in relation to COBRA, it is understood that should the COBRA mandate become irrelevant (e.g. due to the repeal or amendment of the act), the calculation of the time at which use may be made of an HIO is to be made according to the relevant continuation period as herein defined.

In a preferred embodiment of the business method herein disclosed, an individual who wishes to purchase an insurance option (IO) is examined and his “Health Risk Score” (HRS) assessed by use of an HST. Any HST may be used; in a preferred embodiment of the invention, an appropriate embodiment of the case-based computerized HST herein disclosed is used. The HRS is a measure of the overall health of the individual and the likelihood that the individual will need medical treatment in the future. Thus, if the HRS is assigned on a scale of 0-100, an HRS of 100 would indicate perfect health and a small likelihood of the necessity for treatment in the future, while a low HRS would indicate either poor health or a high likelihood of the necessity of future treatment (e.g. due to family health history or risk factors such as smoking).

The party providing the insurance coverage will have defined an acceptable HRS, below which (in the case that a high HRS indicates a low risk to the insurer) the individual is deemed uninsurable. The insurer also provides a set of insurance premiums and benefits to be offered to the individual after a predetermined amount of time. After the individual's HRS has been determined, the insurer then calculates a periodic IO fee. This IO fee will be determined by the risk to the insurer posed by the individual, and may depend on such criteria as (by way of non-limiting example) the predefined HRS; the length of time between the initial purchase of the IO and the right of the individual to make use of it; the length of time during which the individual has the right to make use of the option; the age of the individual at the time of the purchase of the IO; the age of the individual at the time that he or she may first make use of the option; the individual's HRS at the time of the purchase of the option; etc. At the conclusion of the predetermined length of time defined above, the individual's HRS is again determined. In a preferred embodiment of the invention, the HST used at this point is the same one used at the time of sale of the IO so that the means of determining the HRS remains constant. If, for example, due to improvements in risk assessment, an improved HST is available to determine the HRS at the end of the predetermined period, then it can only be used if there is a means of directly calibrating the HRS determined by the new and old HSTs.

If at the end of the predetermined period, the individual's HRS is within the acceptable limits defined at the time of the purchase of the option, then the insurer offers the individual the option of insurance coverage under the conditions agreed to at the time of purchase of the IO. This offer remains valid for a second predetermined period of time, as long as the individual's HRS remains within the acceptable limits previously defined. Upon acceptance of the offer, the insurance coverage is provided to the individual with the premiums and benefits defined at the time of the purchase of the option.

It is acknowledged and emphasized that the business method herein disclosed is applicable to any kind of personal insurance, and is independent of the specific length of time between the purchase of the IO and the individual's right to make use thereof; only the amount of the periodic IO fee will depend on the specific type of insurance under consideration and the relationship between the individual's HRS and the risk that such HRS implies for the insurer in the particular case at hand.

In an alternative embodiment of the invention herein disclosed, the business method is specifically used to provide an individual with a health insurance option (HIO). In this embodiment, upon beginning employment, the individual joins a group health insurance plan (GHIP) and is assigned an HRS. At the time of joining the GHIP, the individual is given the opportunity to purchase a health insurance option (HIO), and a periodic HIO fee is calculated. The periodic HIO fee is proportional to the likelihood that he or she will need medical treatment between the time his continuation period as defined above ends and the time that he becomes eligible for Medicare, i.e. inversely proportional to the HRS. In addition to the risk factors above, the assessment will necessarily take into account such additional factors as the individual's age at joining, the likelihood of early termination, etc. Should the individual choose to purchase an HIO, the HIO fee is added to his periodic GHIP premium. Alternatively, in the case where the GHIP premium is entirely paid for by the employer, the periodic HIO fee will be paid by the employee as an independent payment to the insurer (optionally as a payroll deduction). The frequency of payment of the periodic fee will depend on the details of the individual's employment (e.g. pay period), the convenience of the insurer and the individual, the level of the fee, etc. Note that the periodic fee is not necessarily constant over the period of employment of the individual, and may rise or fall according to the premiums paid by the individual and/or employer to the insurer for participation in the GHIP, the amount of time the employee has been employed, time to retirement, etc.

In order to save on the costs of insuring their employees, many employers choose to offer health insurance in the form of “self-insurance,” that is, the employer acts as the insurer and agrees to pay the employees' health costs in exchange for a periodic fee paid by each employee to the employer rather than as a premium to a third-party insurance company. In cases in which the employer chooses to insure the employees under a self-insurance scheme, the employer frequently chooses to purchase “Stop Loss Insurance,” which provides the employer with coverage in the event that the amount paid out by the employer in a predetermined period of time exceeds a certain predetermined value. In an additional embodiment of the invention herein disclosed, the GHIP to which the individual purchasing the option belongs is a self-insurance scheme provided by the employer. Note that in this embodiment, the continuation period may be one set by company policy rather than by statute or regulation, and may be zero if the employer's policy is to terminate the individual's self-insurance immediately upon termination of employment.

Should the individual's GHIP benefits be terminated, the individual who purchased an HIO then has the right to continue to receive health insurance benefits under the same conditions as his GHIP. The individual may make use of the HIO at any time after the end of the continuation period as long as his HRS remains above a predetermined threshold score. In an alternative embodiment of the invention, the premiums and benefits of the HIO are the same as those as those of the GHIP at the time that the individual chooses to make use of the option. In another alternative embodiment of the invention, during the time that he or she receives health insurance coverage under the HIO, the individual has the right to choose a restricted set of benefits from those available at the time that the HIO becomes effective in exchange for a proportionately lower premium.

In another embodiment of the invention, the individual may make use of the HIO at any time between the end of the continuation period and the earlier of (a) the day his or her HRS falls below a predetermined threshold score and (b) the day that he or she becomes eligible to receive Medicare benefits.

The benefits to the individual of the business method herein disclosed are clear: for a relatively modest fee, the individual insures himself or herself against the possibility that, following loss of health insurance benefits due to (e.g.) termination of employment, he or she will be saved the additional costs of the premiums of an individual health care plan. The benefits to the insurer are equally clear: since most people who purchase the options will not need to make use of them, and most of those who will need to make us them will not do so for a long period after the initial decision to purchase them, proper assessment of the HIO fee will provide a profitable additional source of income to the insurer, not only from the fee itself, but from the profits of investments that can be made between the time the fee is paid and the time that the insurance will have to be paid out.

It is acknowledged and emphasized that the business method disclosed herein does not depend on the method used to determine an individual's HRS. The HRS may be determined, by way of non-limiting example, according to standard actuarial tables, according to any set of criteria felt to be significant by the underwriter who determines the HIO fee, or according to a case-based method as herein described. In one embodiment of the method herein disclosed, the case-based method for determining the HRS comprises the steps of (a) compiling a set of influencing factors; (b) constructing a scoring matrix comprising n rows and n columns, where n is an integer equal to the number of influencing factors, said scoring matrix constructed by (i) assigning each row of said scoring matrix to a unique influencing factor; (ii) assigning each column of said scoring matrix to a unique influencing factor; and (iii) assigning risk score values to each cell in the scoring matrix which correspond to the combined influence of the influencing factors associated with the cell's row and column; (c) obtaining data about at least a portion of the set of influencing factors in at least one case; and (d) determining a total HRS for each case.

It is further acknowledged and emphasized that the business method herein disclosed is independent of the specific benefits available to the insured under the GHIP.

It is further acknowledged and emphasized that neither does the business method disclosed herein depend on the threshold HRS below which it is no longer possible to obtain insurance as provided for by the initial HIO. The insurer can set this minimum HRS to any level consistent with profitability. Indeed, in an alternative embodiment of the invention, the insurer offers a multi-tier HIO, in which a higher HIO fee provides for a lower threshold HRS above which the individual remains entitled to make use of the HIO. This embodiment is analogous to multi-tiered health insurance programs in which more benefits become available to any insured party willing to pay a higher insurance premium.

While the business method herein disclosed has been described in terms of the continuation period mandated by COBRA, it is further acknowledged and emphasized that the method does not depend on this specific statute for its implementation. In alternative embodiments of the invention, the continuation period following the end of the individual's employment is that set by any relevant local, state, or federal law, statute or regulation, or by the policy of the employer with which the GHIP is associated. In a preferred embodiment of the invention, the individual has the right to make use of the HIO at the conclusion of the longest of the possible continuation periods as defined above.

In an alternative embodiment of the invention, should the individual become ill during the time of his employment such that his HRS is below the threshold for the HIO even before his or her participation in the GHIP is terminated, he maintains the right to make use the HIO after the termination of participation in the GHIP. In another alternative embodiment of the invention, such an HIO is presented to the individual as a possible addition to the standard HIO for which an additional fee above the standard HIO fee is charged. In yet another alternative embodiment of the invention, the right to make use of the HIO by an individual who has purchased an HIO that allows for the case of HRS falling below the threshold while the individual is still a member of the GHIP is only valid for a predetermined period after completion of the continuation period as defined above. This predetermined period can be any reasonable period of time set by the insurer; as a non-limiting example, an HIO of this type might include a clause that the right to make use of it expires 24 hours after the conclusion of the continuation period.

In another embodiment of the invention, an individual who finds employment subsequent to making use of the HIO may suspend use of the HIO during the period of subsequent employment and, if necessary, during the continuation period following loss of GHIP benefits from the subsequent period of employment, and resume use of the HIO at any time thereafter during which his or her HRS remains above the threshold. In another embodiment of the invention, the individual who suspends his or her use of the HIO is required to pay a fee during the time that the use of the option is suspended.

In another embodiment of the invention, the HIO is used as supplemental insurance to Medicare for as long as the individual's HRS remains above the threshold. In another embodiment of the invention, an HIO is made available to the individual that is used as supplemental insurance to Medicare regardless of the individual's HRS. An HIO of this sort would optionally involve an additional fee above the regular HIO fee. In another embodiment of the invention, the HIO is used as supplemental insurance to Medicare, but with reduced benefits and a proportionally reduced premium.

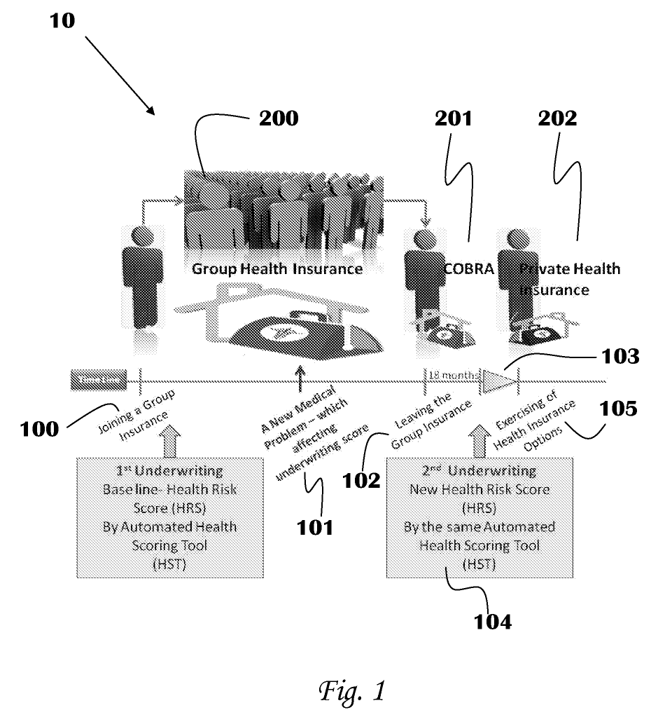

Reference is now made to FIG. 1, which schematically illustrates the timeline of an embodiment 10a of the invention. At time T₀ (100), an individual begins employment and joins a GHIP (200) provided in whole or in part by his employer. At this point, the individual purchases an HIO and is assigned an HRS via an HST. In a preferred embodiment, the HST is a computerized case-based method for risk assessment as disclosed herein. In the particular embodiment illustrated, the individual incurs a medical problem requiring treatment (101). After cessation of employment (102), the individual continues his health insurance in the same GHIP for 18 months (103) as mandated by COBRA statute (201). At this point, the individual undergoes a second assessment of his HRS (104). In a preferred embodiment, this assessment will use the identical HST as was used at time T₀ so that the HRS determined at the termination of his employment will be directly comparable to that determined at the beginning of his employment. In other embodiments, other HSTs may be used (e.g., if risk assessment improves during the interim) as long as a means of calibrating the HRS obtained by the new HST to that obtained by the old one. If the HRS is within the acceptable limits as defined at time T₀, then the HIO purchased at time T₀ is realized: the individual joins a private health insurance organization (202) under the conditions originally negotiated. According to the embodiment illustrated in the figure, since the individual purchased the HIO at the beginning of his employment, he or she retains the right to make use of the HIO and to obtain private health insurance despite having a pre-existing condition that may have lowered his HRS below the threshold for continuation while he or she was still employed.

In an additional embodiment of the invention, insurance options may be sold to a group of individuals. In this embodiment, an HRS is determined for a plurality of individuals. Those whose initial HRS is within a predetermined acceptable limit may join the group insurance option. For the members of the group, a single periodic IO fee is calculated and charged. In addition to the considerations for calculation of the IO fee as discussed above, this group IO fee will be based on the average properties of the members of the group, such as (by way of non-limiting example) the average age at the time of purchase of the option; the average age at the time that the offer to make use of the option becomes valid; the length of time between the initial purchase and the time that the offer is made; the average HRS at the time of purchase of the option; etc. This embodiment combines the advantages of a group insurance plan in which risk is spread over a plurality of individuals with the advantage of the insurance option in which the individual may purchase an option for insurance to take effect only at a predetermined later date.

In addition to the business method disclosed herein, the present invention discloses a system and method for its implementation, namely, a case-based method of data analysis. In one embodiment of the invention herein disclosed, a case based method of data analysis for use in risk assessment is taught, comprising: compiling a set of influencing factors; constructing at least one scoring matrix comprising n rows and n columns, where n is an integer equal to the number of influencing factors, by assigning each row of said scoring matrix to a unique influencing factor; assigning each column of said scoring matrix to a unique influencing factor; and assigning risk score values to each cell in the scoring matrix corresponding to the combined influence of the influencing factors associated with the row and column that define the location of the cell within the matrix; obtaining data about at least a portion of the set of influencing factors in at least one case; and determining a total risk score for each case.

One example of such a method might be, in a non-limiting fashion, in the field of health insurance underwriting where data is obtained relating to a particular case. Influencing factors might therefore include lifestyle factors such as whether the applicant smokes, drinks, regularly engages in sport or physical exercise or other such factors, known diseases affecting the applicant, medication taken by the applicant, known medical procedures undertaken by the applicant or such like. These influencing factors are not essentially independent of one another, so, for example the risk factor associated with an applicant who smokes and suffers from asthma will be higher than either of the two influencing factors separately. The scoring matrix quantifies all such combinations.

Similarly, the system herein disclosed could be used in systems aiding medical diagnosis where influencing factors include parameters such as age, sex and other general factors alongside symptoms presented and medication taken by the patient. Risk scores are calculated based upon combinations of influencing factors which represent the likeliness of the patient of suffering from a given disorder.

Another example from insurance underwriting is vehicle insurance in which the influencing factors include age, sex, neighborhood, accident history, etc. Risk scores are assigned to combinations of these factors.

In an additional embodiment of the current invention, a case based method of data analysis is taught in which a plurality of risk score values is additionally assigned to each cell of the scoring matrix such that a plurality of total risk scores is calculated.

A plurality of total risk scores based upon the same data can serve, in a non-limiting fashion, in an insurance context, to provide a risk score for a plurality of different insurance types. If, for example, the nature of the collected data and influencing factors reflect medical history and lifestyle, the data are relevant to a plurality of insurance types such as medical insurance, life insurance, nursing insurance, disability insurance or other health related insurances. Separate risk scores can thus be calculated for each of these examples. So, for example the risk factor associated with regularly engaging in sport may be lower for life insurance, because the risk of death is reduced, than it would be for health insurance, as the risk of injury is high.

Similarly, as a second example, where insurance is sought for the transport of freight, data relating to a particular cargo can be analysed to produce a plurality of risk scores relating to shipment by land, sea or air.

In an additional embodiment of the current invention, a case based method of data analysis is taught in which a value of at least one combined risk score is additionally assigned that is associated with at least two combined influencing factors that is greater than or equal to the sum of the individual risk scores associated with each influencing factor alone. For example, in the field of health insurance, the case of a combination between asthma and smoking may be higher than either one separately.

In an additional embodiment of the current invention, a case based method of data analysis is taught in which a value is additionally assigned of at least one combined risk score associated with at least two combined influencing factors that is lower than or equal to at least one of the individual risk scores associated with each influencing factor alone. For example in the field of life insurance, an applicant may report an alarmingly high rate of orthopaedic injury the case which by itself represents a high risk; when combined, however, with a lifestyle that includes regular participation in sport, the risk factor is reduced.

In an additional embodiment of the current invention, a case based method of data analysis is taught in which at least one critical influencing factor is additionally assigned, such that where no data is obtained about said critical influencing factor, no risk score is returned.

In an additional embodiment of the current invention, a case based method of data analysis is taught in which a means, such as a database, of storing data obtained from a plurality of cases is additionally assigned.

In an additional embodiment of the current invention, a case based method of data analysis is taught in which at least one reference set of influencing factor values is labelled as significant and provides an alert where a given case approximately matches said reference set.

In an additional embodiment of the current invention, a case based method of data analysis is taught in which risk scores are additionally assigned for sets containing a plurality of individual cases, for example, by averaging or summing all the risk scores of the individual cases in said set.

In an additional embodiment of the current invention, a case based method of data analysis is taught in which a team comprising a plurality of experts with expertise in a plurality of fields is additionally assigned. This team determines the risk score values assigned to each cell in the scoring matrix. Such a team could be a group of doctors who specialize in a plurality of medical fields, who determine the risk scores associated with combinations of medical influencing factors as they relate to life, health, nursing or other health related insurance. Said team can also include non-medical experts for example, military experts, actuarial experts or such like.

In an additional embodiment of the current invention, a case based method of data analysis is taught in which a means such as tele-interviewing of remotely obtaining data is additionally provided.

In an additional embodiment of the current invention, a case based method of data analysis is taught in which risk score values are updated after a fixed period of time.

In an additional embodiment of the current invention, a case based method of data analysis is taught in which a plurality of responses for a plurality of insurance types is selected from inter alia life, health, medical, occupational, vocational, travel, and financial insurance.

In an additional embodiment of the current invention, a case based method of data analysis is taught in which the risk score values of said matrix are additionally adapted to suit a particular user.

In an additional embodiment of the current invention, a case based method of data analysis is taught in which a manual override option is additionally provided.

In an additional embodiment of the current invention, a case based method of data analysis is taught in which automation of the complete underwriting process from application to determining premium and extent of coverage is provided.

In an additional embodiment of the current invention, a case based method of data analysis is taught for use in risk assessment comprising (a) a set of influencing factors; (b) a scoring matrix comprising n rows and n columns, where n is the number of influencing factors wherein (1) each row of said scoring matrix is assigned to a unique influencing factor; (2) each column of said scoring matrix is assigned to a unique influencing factor; and (3) risk score values are assigned to each cell in the scoring matrix which correspond to the combined influence of the influencing factors associated with both the row and the column that define the position of a particular cell within the matrix; (c) a database containing data pertaining to at least a portion of the set of influencing factors in at least one case; and (d) a means of determining a total risk score for each case, for example by summing the risk score values assigned to all the cells of said scoring matrix which are pertinent to the data obtained.

In an additional embodiment of the current invention, a case based method of data analysis is taught additionally comprising a plurality of risk score values assigned to each cell of the scoring matrix such that a plurality of total risk scores are calculated.

In an additional embodiment of the current invention, a case based method of data analysis is taught wherein the value of at least one combined risk score associated with two combined influencing factors is greater than the sum of the individual risk scores associated with each influencing factor alone.

In an additional embodiment of the current invention, a case based method of data analysis is taught wherein the value of at least one combined risk score associated with two combined influencing factors is lower than at least one of the individual risk scores associated with each influencing factor alone.

In an additional embodiment of the current invention, a case based method of data analysis is taught additionally comprising at least one critical influencing factor, such that, where no data is obtained about said critical influencing factor, no risk score is returned.

In an additional embodiment of the current invention, a case based method of data analysis is taught additionally comprising a means, such as a database, of storing data obtained from a plurality of cases.

In an additional embodiment of the current invention, a case based method of data analysis is taught additionally comprising (a) at least one reference set of influencing factor values that are labelled as significant and (b) a means of alerting the user where a given case approximately matches said reference set.

In an additional embodiment of the current invention, a case based method of data analysis is taught additionally comprising risk scores for sets containing a plurality of individual cases calculated, for example, by averaging or summing all the risk scores of the individual cases in said set.

In an additional embodiment of the current invention, a case based method of data analysis is taught additionally comprising a team that comprises a plurality of experts with expertise in a plurality of fields, the team determining the risk score values assigned to each cell in the scoring matrix.

In an additional embodiment of the current invention, a case based method of data analysis is taught additionally comprising a means, such as tele-interviewing, of remotely obtaining data.

In an additional embodiment of the current invention, a case based method of data analysis is taught additionally comprising a means of updating risk score values after a fixed period of time.

In an additional embodiment of the current invention, a case based method of data analysis is taught additionally comprising a plurality of responses for a plurality of insurance types selected from the group consisting of inter alia life, health, medical, occupational, avocational, travel, and financial insurance.

In an additional embodiment of the current invention, a case based method of data analysis is taught additionally comprising a means of adapting the risk score values of said matrix to suit a particular user.

In an additional embodiment of the current invention, a case based method of data analysis is taught additionally comprising a means of providing a manual override.

In an additional embodiment of the current invention, a case based method of data analysis is taught additionally comprising a means of automating the complete underwriting process from application to determination of premiums and the extent of coverage.

In an additional embodiment of the current invention, a case based method of data analysis is taught, additionally comprising the steps of (a) constructing at least a portion of an n-dimensional matrix; (b) associating each of the n axes with a particular influencing factor; and (c) assigning the risk score values associated with any combination of influencing factors to the n-dimensional cell the position of which is defined by the intersection of the axes associated with said n influencing factors for at least a portion of said cells in said n-dimensional matrix.

In an additional embodiment of the current invention, a case based method of data analysis is taught for use in risk assessment comprising (a) compiling a set of influencing factors; (b) constructing a scoring matrix comprising l rows and m columns, where l and m are an integer multiples of the number of influencing factors, said scoring matrix constructed by (1) assigning each row of said scoring matrix to a unique influencing factor; (2) assigning each column of said scoring matrix to a unique influencing factor; and (3) assigning a risk score value to each cell in the scoring matrix, said risk score values corresponding to the combined influences of the influencing factors associated with the row and column defining the location of said cell within said scoring matrix; obtaining data about at least a portion of the set of influencing factors in at least one case; and determining a total risk score for each case.

In an additional embodiment of the current invention, a case based method of data analysis is taught for use in risk assessment comprising (a) a set of influencing factors; (b) a scoring matrix comprising l rows and m columns, where l and m are an integer multiples of the number of influencing factors, wherein (1) each row of said scoring matrix is assigned to a unique influencing factor; (2) each column of said scoring matrix is assigned to a unique influencing factor; and (3) risk score values are assigned to each cell in the scoring matrix, said risk score values corresponding to the combined influences of the influencing factors associated with the row and column defining the location of said cell within said scoring matrix; (c) a database containing data pertaining to at least a portion of the set of influencing factors in at least one case; and (d) a means of determining a total risk score for each case, for example by summing the risk score values assigned to all the cells of said scoring matrix which are pertinent to the data obtained.

An advantage of the l by m scoring matrix is that with such a matrix it is possible to include a plurality of risk scores for each combination in a single matrix format.

It is noted with regard to the means and method herein described that
1. the assessment of both individuals and groups of individuals is enabled,
2. the data used for the assessment may be obtained from a plurality of sources,
3. assessment for a particular case or group of cases is based upon the data gathered for that case in a manner such that the assessment grading is updated as each additional datum is obtained, and
4. the accuracy of the assessment can increase as the quantity of data increases.

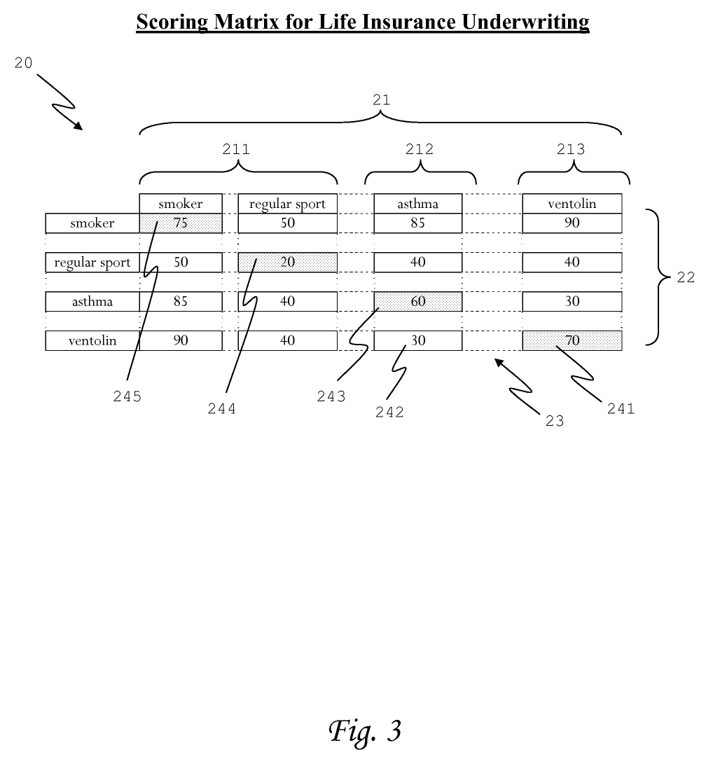

Reference is now made to FIG. 3 which represents, in the form of a flow diagram, the main stages involved in determining the total risk score for a particular case, according to one embodiment of the current invention. First, a set of influencing factors is compiled, 11. A team, for example a team of doctors who are specialists in different fields of medicine, assigns risk scores to each combination of influencing factors, 12, and these values are used to construct the scoring matrix for the particular risk, 13. Data is gathered in reference to a particular case, 14, and the scoring matrix is then used to determine the total risk-score, 15.

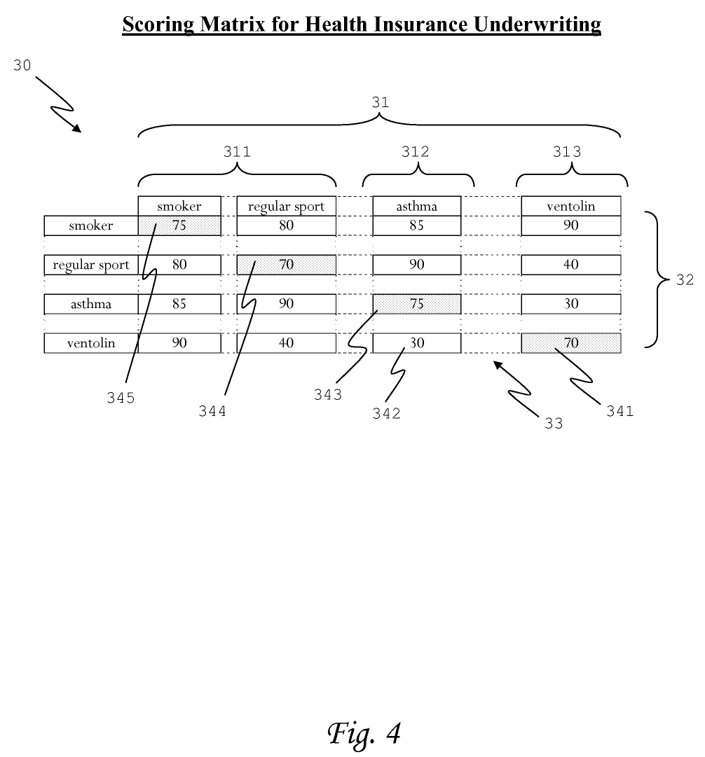

Reference is now made to FIG. 4 which schematically represents a greatly simplified example of a scoring matrix, 20, for use in life insurance underwriting, according to another embodiment of the current invention. The matrix is comprises an arrangement of cells into rows, 22, and columns, 21. Each row or column is assigned to a separate influencing factor. The dotted lines, 23, indicate that a great many more influencing factors will exist than illustrated here. In the matrix shown in FIG. 3, two influencing factors related to lifestyle, 211, are presented (smoker and regular sport), alongside one known disease, 212, (asthma) and one medication, 213, (Ventolin™). Each of the shaded cells 241, 243, 244 and 245 represents the risk score of a single influencing factor. Thus, cell 241 indicates that an individual taking the medication Ventolin™ has an associated risk score of 70, as this may indicate, in the absence of further data, either severe asthma or emphysema. Similarly, cell 243 indicates that a case known to be suffering from asthma has an associated risk score of 60. Note, however, that the combined risk score of a case known to have asthma and to be undergoing treatment with Ventolin™ is reduced to 30, cell 242, as this represents a smaller risk.

The same influencing factors are displayed again in FIG. 5. This figure presents a greatly simplified example of a scoring matrix, 30, for health insurance underwriting, according to another embodiment of the current invention. Note that although this scoring matrix, 30, has the same structure as that of scoring matrix 20, the risk score values for health insurance differ from those for life insurance shown in matrix 20. For example, the risk score value for regular participation in sport, cell 344, is much higher (70) for health insurance than the corresponding cell, 244, in the life insurance table (20). This reflects the increased likeliness of costs related to injury which is not life threatening. This demonstrates the versatility of the structure, which can construct multiple results from a single set of data.

As described above, one important step in the business method for providing health insurance options described above is the assignment of the individual's HRS. The case-based method disclosed herein is an ideal method for calculating the HRS. In alternative embodiments of the business method, the HRS can be determined by using any one of the embodiments of the case-based risk assessment method herein disclosed, using a matrix of the type shown in FIG. 4. Which embodiment of the case-based risk assessment method will be used in a particular instance will depend on the particular needs of the individual, GHIP, and insurer.

### EXAMPLES

A sample hypothetical case is now presented as an example of how the method is applied. As described above, the case is based on an HRS assessment method that yields an HRS from 100 (most healthy) to zero (least healthy), with the threshold for continued coverage under the method disclosed herein set at 60. When the individual in question begins work for an employer, he receives an HRS of 90. At that time, he purchases an HIO, the premium for which is based on his age and this HRS. At some later time, his employment ceases, and his HRS is once again assessed and found to be 80. He is eligible to make use of the HIO any time after the 18 month period covered by COBRA as long as his HRS remains above 60. Thus, if at the end of the 18 month period, his HRS is 70, he may (but need not) immediately make use of the HIO that he purchased at the commencement of his employment. If he waits, for example, an additional year after the conclusion of the 18 month period covered by COBRA without making use of the HIO, and at the end of that additional year, his HRS is found to be 70, he may make use of the option at that point. If, on the other hand, his HRS had fallen to 55 in the interim, he has abandoned the right to make use of the HIO.

In a second hypothetical example, a male individual who is 33 years old male purchases an option for the right to obtain up to $1 million in risk-only life insurance, the option being for 17 years, (i.e. until he reaches age 50). His HRS as determined by one of the embodiments described above is calculated on the day that he purchases the option purchasing day and is 68. He purchases an option that allows a health status change magnitude of up to 23 points, i.e. to a threshold score of 45. (In this specific example, a lower score is equivalent to worse health). When the individual reaches age 50, his HRS is recalculated. If it is still above 45, then the person will be able to buy the insurance at the predetermined price. A lower HRS at age 50 will increase the insurance premium by a predetermined amount, depending on the actual score measured. Below a second minimum score the option expires.

1. A case based method of data analysis for use in risk assessment comprising the steps of:
a. compiling a set of influencing factors;
b. constructing at least one scoring matrix comprising n rows and n columns, where n is an integer equal to the number of influencing factors, said scoring matrix constructed by
i. assigning each row of said scoring matrix to an influencing factor;
ii. assigning each column of said scoring matrix to an influencing factor; and,
iii. assigning risk score values to each cell in said scoring matrix, said risk score values corresponding to the combined influences of the influencing factors associated with the row and column defining the location of said cell within said scoring matrix;
c. obtaining data about at least a portion of the set of influencing factors in at least one case; and,
d. determining an overall response for each case.

2. The method according to claim 1, additionally assigning a plurality of risk score values to each cell of the scoring matrix such that a plurality of total risk scores are calculated.

3. The method according to claim 1, additionally assigning a value of at least one combined risk score associated with at least two combined influencing factors that is greater than or equal to the sum of the individual risk scores associated with each influencing factor alone.

4. The method according to claim 1, additionally assigning a value of at least one combined risk score associated with at least two combined influencing factors that is lower than or equal to at least one of the individual risk scores associated with each influencing factor alone.

5. The method according to claim 1, additionally identifying at least one critical influencing factor, such that where no data is obtained about said critical influencing factor no risk score is returned.

6. The method according to claim 1, additionally providing a means, especially a database, of storing data obtained from a plurality of cases.

7. The method according to claim 1, additionally labelling at least one reference set of influencing factor values as significant and providing an alert where a given case approximately matches said reference set.

8. The method according to claim 1, additionally providing risk scores for sets containing a plurality of individual cases, especially by averaging or summing all the risk scores of the individual cases in said set.

9. The method according to claim 1, additionally providing a team comprising a plurality of experts with expertise in a plurality of fields, said team determining the risk score values assigned to each cell in said scoring matrix.

10. The method according to claim 1, additionally providing a remote means, especially tele-interviewing, of remotely obtaining data.

11. The method according to claim 1, additionally updating risk score values after a fixed period of time.

12. The method according to claim 1, additionally providing a plurality of responses for a plurality of insurance types, selected from the group consisting of life, health, medical, occupational, vocational, travel, financial insurance types or any combination thereof.

13. The method according to claim 1, additionally adapting the risk score values of said matrix to suit a particular user.

14. The method according to claim 1, additionally providing a manual override option.

15. The method according to claim 1, providing automation of the complete underwriting process from application to determining premium and extent of cover.

16. The method according to claim 1, additionally comprising the steps of
a. constructing at least a portion of an n-dimensional matrix;
b. associating each of the n axes with a particular influencing factor; and
c. assigning the risk score values associated with any combination of influencing factors to the n-dimensional cell the position of which is defined by the intersection of the axes associated with said n influencing factors for at least a portion of said cells in said n-dimensional matrix.

17. A case based system of performing data analysis for use in risk assessment comprising:
a. a set of influencing factors;
b. a scoring matrix comprising n rows and n columns, where n is the number of influencing factors wherein
i. each row of said scoring matrix is assigned to a unique influencing factor;
ii. each column of said scoring matrix is assigned to a unique influencing factor; and,
iii. risk score values are assigned to each cell in said scoring matrix, said risk score values corresponding to the combined influences of the influencing factors associated with the row and column defining the location of said cell within said scoring matrix;
c. a database containing data pertaining to at least a portion of the set of influencing factors in at least one case; and,
d. a means of determining a total risk score for each case, especially by summing the risk score values assigned to all the cells of said scoring matrix which are pertinent to the data obtained.

18. The system according to claim 17, additionally comprising a plurality of risk score values assigned to each cell of said scoring matrix such that a plurality of total risk scores are calculated.

19. The system according to claim 17, wherein the value of at least one combined risk score associated with at least two combined influencing factors is greater than or equal to the sum of the individual risk scores associated with each influencing factor alone.

20. The system according to claim 17, wherein the value of at least one combined risk score associated with at least two combined influencing factors is lower than or equal to at least one of the individual risk scores associated with each influencing factor alone.

21. The system according to claim 17, additionally comprising at least one critical influencing factor, such that where no data is obtained about said critical influencing factor, no risk score is returned.

22. The system according to claim 17, additionally comprising a means, such as a database, of storing data obtained from a plurality of cases.

23. The system according to claim 17, additionally comprising at least one reference set of influencing factor values which are labelled as significant and a means of alerting the user where a given case approximately matches said reference set.

24. The system according to claim 17, additionally comprising risk scores for sets containing a plurality of individual cases calculated for example by averaging or summing all the risk scores of the individual cases in said set.

25. The system according to claim 17, additionally comprising a team, of a plurality of experts with expertise in a plurality of fields, which determines the risk score values assigned to each cell in said scoring matrix.

26. The system according to claim 17, additionally comprising a remote means, especially tele-interviewing of remotely obtaining data.

27. The system according to claim 17, additionally comprising a means of updating risk score values after a fixed period of time.

28. The system according to claim 17, additionally comprising a plurality of responses for a plurality of insurance types selected from a group including life, health, medical, occupational, vocational, travel, financial insurance types or any combination thereof.

29. The system according to claim 17, additionally comprising a means of adapting the risk score values of said matrix to suit a particular user.

30. The system according to claim 17, additionally comprising a means of providing a manual override.

31. The system according to claim 17, additionally comprising a means of automating of the complete underwriting process from application to determining premium and extent of cover.

32. The system according to claim 17, additionally comprising at least a portion of an n-dimensional matrix and a means of providing at least a portion of the risk score values associated with any combination of a plurality of influencing factors.

33. A case based method of data analysis for use in risk assessment comprising:
a. compiling a set of influencing factors;
b. constructing a scoring matrix comprising l rows and m columns, where l and m are integer multiples of the number of influencing factors, said scoring matrix constructed by
i. assigning each row of said scoring matrix to a unique influencing factor;
ii. assigning each column of said scoring matrix to a unique influencing factor; and,
iii. assigning risk score values to each cell in said scoring matrix, said risk score values corresponding to the combined influences of the influencing factors associated with the row and column defining the location of said cell within said scoring matrix;
c. obtaining data about at least a portion of the set of influencing factors in at least one case; and,
d. determining a total risk score for each case.

34. A case based system of performing data analysis for use in risk assessment comprising:
a. a set of influencing factors;
b. a scoring matrix comprising l rows and m columns, where l and m are integer multiples of the number of influencing factors, wherein
i. each row of said scoring matrix is assigned to a unique influencing factor;
ii. each column of said scoring matrix is assigned to a unique influencing factor; and,
iii. risk score values are assigned to each cell in said scoring matrix, said risk score values corresponding to the combined influences of the influencing factors associated with the row and column defining the location of said cell within said scoring matrix;
c. a database containing data pertaining to at least a portion of the set of influencing factors in at least one case; and,
d. a means of determining a total risk score for each case, for example by summing the risk score values assigned to all the cells of said scoring matrix which are pertinent to the data obtained.

35. A method of doing business for personal insurance options (IOs), comprising the steps of:
a. defining an acceptable health risk score (HRS);
b. defining a set of insurance premiums and benefits to be offered to an individual after a predetermined period of time;
c. using a health scoring tool (HST) to calculate an HRS for an individual;
d. calculating a periodic IO fee for said individual;
e. selling said individual said an IO in exchange for agreement to pay said periodic IO fee;
f. using an HST to calculate a second HRS at the conclusion of said predetermined length of time defined in step (b);
g. offering insurance coverage to said individual if said second HRS is acceptable according to the definition of step (a), said offer remaining valid for a predetermined time after the completion of the period of time defined in step (b) as long as said individual's HRS remains acceptable according to the definition of step (a); and,
h. providing insurance coverage to said individual upon said individual's acceptance of said offer of insurance coverage;
wherein said insurance coverage is provided with said set of premiums and benefits as defined in step (b).

36. The business method of claim 35, wherein at least one of said HSTs is automated and/or computerized.

37. The business method of claim 35, wherein the HST of step (f) is identical to the HST of step (c).

38. The business method of claim 35, wherein the periodic IO fee is calculated based on criteria chosen from the group consisting of (i) the acceptable HRS as defined in step (a); (ii) the length of said predetermined period as defined in step (b); (iii) the length of the period of validity of said offer as defined in step (g); (iv) the age of said individual at the end of said predetermined period as defined in step (b); (v) any combination of the above.

39. The business method of claim 35, wherein the IO is a health insurance option, and further comprising the additional steps of:
a. accepting said individual into a group health insurance plan (GHIP), said GHIP affiliated with said individual's employer;
b. assigning the beginning said predetermined period of time as defined in step (b) to the day after the last day of said individual's membership in said GHIP;
c. offering said individual health insurance coverage, said predetermined period of validity of said offer beginning the day after the last day of the longest continuation period of those in the group consisting of (i) the continuation period mandated by COBRA, (ii) the continuation period mandated by any other local, state, or federal law, statute, or regulation, and (iii) the continuation period mandated by company policy, and ending the day that said individual's HRS falls outside of said predetermined acceptable limit; and
d. providing said individual health insurance coverage upon said individual's acceptance of said offer of health insurance coverage;
wherein said health insurance coverage is provided with the same premiums and benefits as provided by said GHIP on the last day of the continuation period of step (f).

40. The business method of claim 39, wherein said GHIP is provided to said individual by said individual's employer as self-insurance.

41. The business method of claim 39, wherein said step of offering said individual health insurance coverage remains valid during a period of time beginning the day after said continuation period ends and ending the earliest of (a) a predetermined expiration date; (b) the day that said individual's HRS falls below a predetermined threshold value; and (c) the day that said individual becomes eligible to receive Medicare benefits.

42. The business method of claim 39, wherein said health insurance coverage is provided with the same premiums and benefits as provided by said GHIP on the day that said offer is accepted by said individual.

43. The business method of claim 39, further comprising the additional step of creating a plurality of HIOs, each of said HIOs having a predetermined unique set of benefits; wherein said step of calculating a periodic HIO fee further comprises the step of calculating a periodic fee for each of said plurality of HIOs; and further wherein the step of selling said individual said HIO in exchange for agreement to pay said periodic HIO fee further comprises the step of selling said individual at least one of said plurality of HIOs in exchange for agreement to pay the periodic fee associated with said HIO.

44. The business method of claim 39, wherein said health insurance coverage is provided with a predetermined set of benefits, said set of benefits more restrictive than those provided by said GHIP, and further wherein the premium for participation in said health insurance coverage is reduced relative to the premium for participation in said GHIP.

45. The business method of claim 43, wherein said individual retains the right to make use of said HIO after the conclusion of said continuation period in the event that said individual's HRS falls below said threshold value during the period of said individual's participation in said GHIP.

46. The business method of claim 43, wherein at least one of said plurality of HIOs includes the retention of the right to make use of said HIO after the conclusion of said continuation period in the event that said individual's HRS falls below said threshold value during the period of said individual's participation in said GHIP, and further wherein said periodic fee for said HIO is higher than the fee for an HIO that is otherwise identical but does not contain any provision for the event of said individual's HRS falling below said threshold during said period of participation in said GHIP.

47. The business method of claim 45, wherein the right to make use of said HIO expires a predetermined period after the expiration of said continuation period.

48. The business method of claim 46, wherein the right to make use of said HIO expires a predetermined period after the expiration of said continuation period.

49. The business method of claim 35, further comprising the additional step of suspending said health insurance coverage during any period of time during which said individual obtains employment that includes the option of joining a GHIP.

50. The business method of claim 49, further comprising the additional step of resuming collection of said periodic HIO fee during said period of time during which said health insurance coverage is suspended.

51. The business method of claim 35, wherein after said individual becomes eligible to receive Medicare benefits, said HIO includes health insurance coverage as a supplement to Medicare benefits.

52. The business method of claim 51, wherein said supplement to Medicare benefits comprises a predetermined set of benefits, said set of benefits more restrictive than those provided by said GHIP, and further wherein the premium for participation in said health insurance coverage is reduced relative to the premium for participation in said GHIP.

53. The business method of claim 35, further comprising the additional steps of:
a. performing the step of using an HST to calculate an HRS for each of a plurality of individuals;
b. selecting from within said plurality of individuals a group of individuals all of whom have an acceptable HRS; and,
c. calculating a periodic IO fee for each of said individuals, said IO fee identical for each of said individuals;
wherein said IO fee is calculated based on criteria selected from the group consisting of (i) the acceptable HRS; (ii) the length of said predetermined period as defined in step (b) of claim 35; (iii) the average age of said individuals in said group; (iv) the average HRS of said individuals in said group; (v) the average age of said individuals at the end of said predetermined period as defined in step (b) of claim 35; (vi) the length of the period of validity of said offer as defined in step (g) of claim 35; (vii) any combination of the above.

54. The business method of claim 35, wherein said step of determining an HRS range further comprises the additional step of using the method of claim 1 to determine said HRS range.

55. The business method of claim 35, further comprising the additional steps of:
a. determining an HRS range;
b. selecting a portfolio of insured individuals within said HRS range; and,
c. issuing financial instruments secured by said portfolio.

56. The business method of claim 35, wherein said HST comprises the method of claim 1.
